(19) United States
(12) Patent Application Publication
(10) Pub. No.: US 2026/0300192 A1
(43) Pub. Date: Oct. 1, 2026

(54) Data Transfer Device for Heterogeneous Memory Systems

(71) Applicant: Advanced Micro Devices, Inc., Santa Clara, CA (US)

(72) Inventors: Johnathan Robert Alsop, Seattle, WA (US); Karthik Ramu Sangaiah, Seattle, WA (US); Muhammad Abdelghaffar Awad, Santa Clara, CA (US); Emily Anne Furst, Duvall, WA (US); Ioannis Papadopoulos, Waltham, MA (US); Georgios Tziantzioulis, Belmont, MA (US)

(73) Assignee: Advanced Micro Devices, Inc., Santa Clara, CA (US)

(21) Appl. No.: 19/095,947

(22) Filed: Mar. 31, 2025

(51) Int. Cl. G06F 13/16; G06F 12/02

(52) U.S. Cl. CPC G06F 13/1626; G06F 12/0246; G06F 13/1673

(57) ABSTRACT

Data transfer for heterogenous memory systems is described. In one or more implementations, a data transfer device includes a controller and transfer logic. The controller receives a data transfer request from a processor and, responsive to the request, obtains data from a source memory location and transfers data to a destination memory location. During the transfer, the transfer logic performs at least one data transfer operation in relation to the data to optimize the transfer. Examples of data transfer operations include controlling data access order, rearranging the data, and modifying the data.

### BACKGROUND

Modern computing systems often involve heterogeneous memory architectures with diverse storage and processing components, such as central processing units (CPUs), graphics processing units (GPUs), accelerators, and specialized memory units. These systems frequently require data to be transferred between different memory spaces, each with unique characteristics such as addressing schemes, data formats, and access patterns. Efficiently moving and transforming data between these heterogeneous components presents significant challenges, as optimal data layouts and access methods can vary widely depending on the specific hardware and workload. Traditional data transfer mechanisms may not adequately address the complexities of these diverse memory ecosystems, potentially leading to suboptimal performance and resource utilization in data-intensive applications like artificial intelligence, high-performance computing, and graph processing.

### BRIEF DESCRIPTION OF THE DRAWINGS

FIG. 1 is a block diagram of a processing system configured to execute one or more applications, in accordance with one or more implementations.

FIG. 2 is a block diagram of a non-limiting example system having a data transfer device to transfer data between heterogeneous memory systems.

FIG. 3 is a block diagram of another non-limiting example system having a data transfer device to transfer data between heterogeneous memory systems.

FIG. 4 depicts a procedure in an example implementation of data transfer for heterogeneous memory systems.

FIG. 5 depicts a procedure in an example implementation of optimizing data access order for dynamic random access memory (DRAM) access optimization.

FIG. 6 depicts a procedure in an example implementation of data structure layout transformation for heterogeneous memory systems.

FIG. 7 depicts a procedure in an example implementation of message passing interface (MPI) datatype transfer support for heterogeneous memory systems.

FIG. 8 depicts a procedure in an example implementation of sampling large datasets for heterogeneous memory systems.

FIG. 9 depicts a procedure in an example implementation of graph data transformation for heterogeneous memory systems.

FIG. 10 depicts a procedure in an example implementation of matrix transformation for deep neural networks using a data transfer device.

### DETAILED DESCRIPTION

In emerging computing systems, application performance may be increasingly constrained by data movement. As systems evolve towards greater specialization in compute and data storage capabilities, there is a trend towards increased heterogeneity in optimal data access and storage methods. This is particularly evident in artificial intelligence (AI) and graph processing workloads, where different accelerators may prefer or require specific data formats and layouts. When transferring data in such heterogeneous systems, it may be insufficient for software and/or hardware to employ a single address mapping or interleaving strategy, data format, cache block size, or dynamic random-access memory (DRAM) architecture to achieve optimal performance and energy efficiency. The optimal data access order may depend on the memory architecture, potentially to exploit row locality or bank parallelism. Similarly, the optimal data layout may be influenced by the specific accelerator in use, such as different variants of processor-in-memory having distinct data layout requirements, or by dynamic workload characteristics, such as whether a matrix is accessed in a row-first or column-first pattern with or without tiling. Many emerging accelerators and workloads may benefit from data transformations, including conversions between array-of-structure (AoS) and structure-of-array (SoA) formats, compressed sparse row/column (CSR/CSC) representations, data sampling, compression and decompression, and image-to-column (im2col) transformations.

Conventional data transfer techniques in heterogeneous computing systems often rely on software-based approaches or simple direct memory access (DMA) operations. These traditional methods typically move data between memory spaces without considering the unique characteristics and requirements of different hardware components. As a result, additional software-based transformations through preprocessing or postprocessing are required, leading to suboptimal performance, increased latency, and inefficient resource utilization, particularly in complex systems involving diverse accelerators, processors, and memory architectures.

To address these limitations, a data transfer device for heterogeneous memory systems is leveraged. The data transfer device is a specialized device that is configured to intelligently handle data movement and transformation between heterogeneous memory systems. This data transfer device includes a controller and transfer logic, working in tandem to optimize data transfers based on the specific requirements of both source and destination memory spaces.

In one or more implementations, the controller of the data transfer device receives data transfer requests from a processor and manages the overall transfer process. Responsive to a data transfer request, the data transfer device obtains data from a source memory location and coordinates the transfer of the data to a destination memory location. The transfer logic is configured to optimize the transfer of the data by performing one or more data transfer operations in connection with the data transfer, such as by controlling data access order (e.g., at the source memory location and/or the destination memory location) or performing one or more data transformations, such as data rearrangement and/or data manipulation. When a data transfer request is accompanied by one or more transformation requests, for instance, the transfer logic performs one or more data transformation operations on the obtained data, generating transformed data that is ultimately transferred to the destination. As noted above, examples of such transformations include data rearrangement and data manipulation. When no transformations are required, though, the data transfer device transfers the data back to the destination without any transformations. In such cases, a data transfer operations such as controlling the access order may be performed.

The described systems, devices, and techniques allow for independent operation, as the data transfer device can obtain the data, perform transfer operations, and transfer the data without further involvement from the requesting processor. The device can also notify the processor upon completion of the transfer, enabling efficient coordination of subsequent operations.

The data transfer device is capable of handling transfers between different types of memory, accommodating the diverse memory architectures found in modern computing systems. It can process data transfer requests that specify not only source and destination locations but also the size of the data to be transferred and even complex mapping functions between source and destination addresses.

The data transfer devices are configured to perform various types of transfer operations, including rearranging data elements or manipulating the data itself, allowing for optimizations such as converting between array-of-structure (AoS) and structure-of-array (SoA) formats, transforming sparse matrix representations, or performing data type conversions. The data transfer device can also modify access orders to optimize for specific memory architecture characteristics which improves performance by exploiting features like DRAM row locality or bank parallelism.

To support the transfer operations, the data transfer device may incorporate intermediate storage buffers for temporary data storage during transformations. It may also include specialized logic for generating source, intermediate, and destination addresses, further enhancing its ability to optimize data movement patterns.

The systems, devices, and techniques described herein offer several advantages over conventional systems. Offloading data transfer tasks from the processor frees up computational resources for other tasks. The ability to perform operations to optimize a transfer can reduce the total amount of data moved which decreases latency and energy consumption. Additionally, by optimizing access patterns and data layouts for specific hardware components, the described systems, devices, and techniques can improve overall performance in heterogeneous computing environments, particularly for data-intensive applications in fields such as artificial intelligence, high-performance computing, and graph processing. Moreover, the data transfer device enables more efficient sharing of data between devices with different memory architectures or data format preferences. The ability to perform complex transformations during transfer may also reduce the need for separate data conversion steps in conventional data transfer workflows. Furthermore, the flexible architecture of the data transfer device allows it to be adapted for optimizing various types of data transformations and access orders as new memory technologies emerge.

In some aspects, the techniques described herein relate to a data transfer device including: a controller configured to: receive a data transfer request from a processor, and responsive to the data transfer request, obtain data from a source memory location and transfer the data to a destination memory location, and transfer logic configured to optimize the transfer of the data from the source memory location to the destination memory location by performing at least one data transfer operation.

In some aspects, the techniques described herein relate to a data transfer device, wherein the data transfer device obtains the data, performs the at least one data transfer operation on the data, and transfers the data to the destination memory location independently of the processor.

In some aspects, the techniques described herein relate to a data transfer device, wherein controller is further configured to notify the processor that the transfer is complete after an optimized transfer of the data to the destination memory location.

In some aspects, the techniques described herein relate to a data transfer device, wherein the source memory location and the destination memory location are in different types of memory.

In some aspects, the techniques described herein relate to a data transfer device, wherein the data transfer request identifies the source memory location, the destination memory location, and a size of the data.

In some aspects, the techniques described herein relate to a data transfer device, wherein the at least one data transfer operation includes rearranging data elements of the data to generate transformed data.

In some aspects, the techniques described herein relate to a data transfer device, wherein the at least one data transfer operation includes manipulating the data to generate transformed data.

In some aspects, the techniques described herein relate to a data transfer device, wherein the data transfer request specifies a source address to destination address mapping function.

In some aspects, the techniques described herein relate to a data transfer device, wherein the at least one data transfer operation includes controlling an access order to obtain the data from the source address or transfer the data to the destination based on the mapping function.

In some aspects, the techniques described herein relate to a data transfer device, wherein the access order is modified to optimize for memory architecture characteristics of the source memory location and the destination memory location.

In some aspects, the techniques described herein relate to a data transfer device, further including at least one intermediate storage buffer configured to temporarily store data during the at least one data transfer operation.

In some aspects, the techniques described herein relate to a data transfer device, further including source address generation logic, intermediate address generation logic, and destination address generation logic.

In some aspects, the techniques described herein relate to a data transfer device, wherein the transfer logic is coupled to the controller.

In some aspects, the techniques described herein relate to a data transfer device, wherein the transfer logic is implemented as a part of the controller.

In some aspects, the techniques described herein relate to a system including: a processor, memory including a first memory space and a second memory space, the second memory space being heterogeneous to the first memory space, and a data transfer device configured to: receive a data transfer request from the processor, responsive to the data transfer request, obtain data from a first memory location in the first memory space, transfer the data from the first memory location to a second memory location in the second memory space, and optimize the transfer of the data from the first memory location to the second memory location by performing at least one data transfer operation.

In some aspects, the techniques described herein relate to a system, wherein the first memory space and the second memory space are implemented using different physical memory systems.

In some aspects, the techniques described herein relate to a system, wherein the first memory space and the second memory space are implemented at a same physical memory module.

In some aspects, the techniques described herein relate to a method including: receive, by a data transfer device, a data transfer request from a processor, responsive to the data transfer request, obtain, by the data transfer device, data from a source memory location, temporarily store, by the data transfer device, the data during at least one data transfer operation performed by the data transfer device to optimize transfer of the data between the source memory location and a destination memory location, and transfer, by the data transfer device, the data to the destination memory location.

In some aspects, the techniques described herein relate to a method, further including: generating, by the data transfer device, a mapping function for converting source addresses to destination addresses, and modifying, by the data transfer device, an access order for obtaining the data from the source memory location or transforming the data for transfer to the destination memory location based on the mapping function.

In some aspects, the techniques described herein relate to a method wherein transforming the data for transfer includes at least one of: rearranging data elements of the obtained data to generate transformed data, and converting the obtained data from a first data type to a second data type.

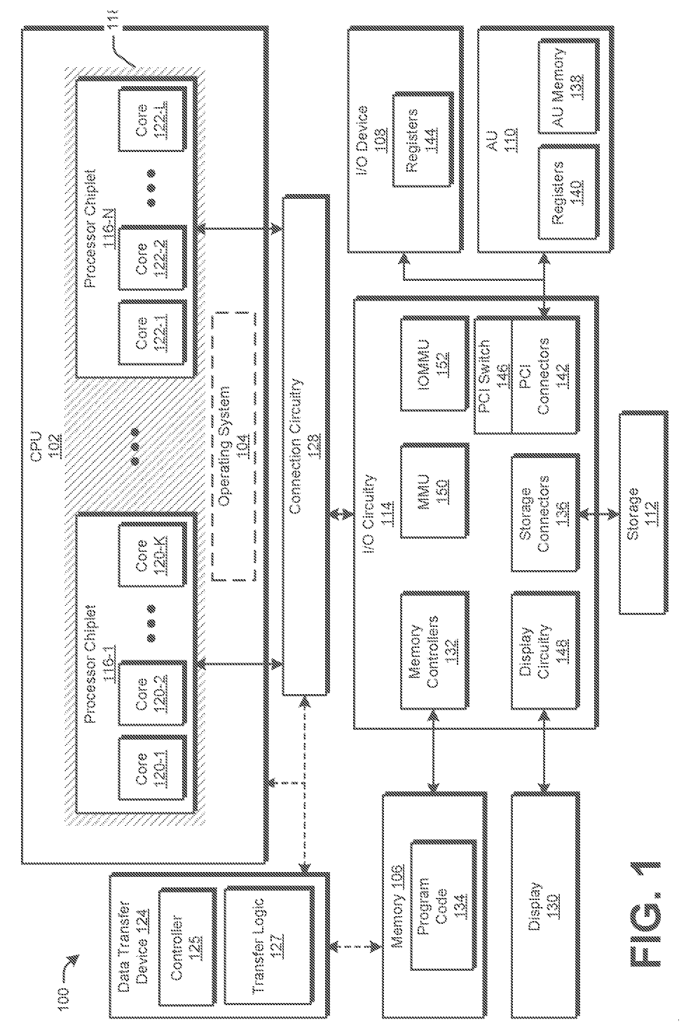

FIG. 1 is a block diagram of a processing system configured to execute one or more applications, in accordance with one or more implementations.

FIG. 1 includes a processing system 100 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 112, I/O circuitry 114) for the execution of tasks for the applications, provide an interface to I/O devices (e.g., I/O device 108) for the applications, or any combination thereof.

The CPU 102 includes one or more processor chiplets 116, which are communicatively coupled together by a data fabric 118 in one or more implementations.

Each of the processor chiplets 116, for example, includes one or more processor cores 120, 122 configured to concurrently execute one or more series of instructions, also referred to herein as “threads,” for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116. Though the example embodiment presented in FIG. 1 shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

In this example, data transfer device 124 is depicted coupled to the memory 106. Additionally, the data transfer device 124 is depicted including a controller 125 (e.g., a memory controller) and transfer logic 127. Broadly, the data transfer device 124 is a hardware device in communication with at least two devices or systems, e.g., of the processing system 100, that access memory heterogeneously, such as the CPU 102 and the AU 110. Although the CPU 102 and the AU 110 are mentioned here, the data transfer device 124 may be used to improve data transfers between various other devices or systems that access memory heterogeneously in accordance with the described techniques. The data transfer device 124 can be communicably coupled to two such devices or systems in any of a variety of ways, such as by using any of a variety of connections, e.g., via connection circuitry 128. Although depicted as being coupled to the CPU 102, the system memory 106, and the connection circuitry 128, in variations the data transfer device 124 is coupled to different devices of a processing system 100.

Additionally, within the processing system 100, the CPU 102 is communicatively coupled to an I/O circuitry 114 by a connection circuitry 128. For example, each processor chiplet 116 of the CPU 102 is communicatively coupled to the I/O circuitry 114 by the connection circuitry 128. The connection circuitry 128 includes, for example, one or more data fabrics, buses, buffers, queues, and the like. The I/O circuitry 114 is configured to facilitate communications between two or more components of the processing system 100 such as between the CPU 102, system memory 106, display 130, universal serial bus (USB) devices, peripheral component interconnect (PCI) devices (e.g., I/O device 108, AU 110), storage 112, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 114 includes one or more memory controllers 132. These memory controllers 132, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, these memory controllers 132 are configured to manage access to the data stored at one or more memory addresses within the system memory 106, such as by CPU 102, the I/O device 108, and/or the AU 110.

When an application is to be executed by processing system 100, the OS 104 running on the CPU 102 is configured to load at least a portion of program code 134 (e.g., an executable file) associated with the application from, for example, a storage 112 into system memory 106. This storage 112, for example, includes a non-volatile storage such as a flash memory, solid-state memory, hard disk, optical disc, or the like configured to store program code 134 for one or more applications.

To facilitate communication between the storage 112 and other components of processing system 100, the I/O circuitry 114 includes one or more storage connectors 136 (e.g., universal serial bus (USB) connectors, serial AT attachment (SATA) connectors, PCI Express (PCIe) connectors) configured to communicatively couple storage 112 to the I/O circuitry 114 such that I/O circuitry 114 is capable of routing signals to and from the storage 112 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 138. This AU memory 138, for example, includes any combination of one or more volatile memories and/or non-volatile memories, examples of which include caches, video RAM (VRAM), or the like. In one or more implementations, these compute units are also configured to execute these threads based on the data stored in one or more physical registers 140 of the AU 110.

To facilitate communication between the AU 110 and one or more other components of processing system 100, the I/O circuitry 114 includes or is otherwise connected to one or more connectors, such as PCI connectors 142 (e.g., PCIe connectors) each including circuitry configured to communicatively couple the AU 110 to the I/O circuitry such that the I/O circuitry 114 is capable of routing signals to and from the AU 110 to one or more other components of the processing system 100. Further, the PCIe connectors 142 are configured to communicatively couple the I/O device 108 to the I/O circuitry 114 such that the I/O circuitry 114 is capable of routing signals to and from the I/O device 108 to one or more other components of the processing system 100.

By way of example and not limitation, the I/O device 108 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 144 of the I/O device 108. In one or more implementations, such physical registers 144 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 142, and one or more other components of the processing system 100, the I/O circuitry 114 includes PCI switch 146. The PCI switch 146, for example, includes circuitry configured to route packets to and from the components of the processing system 100 connected to the PCI connectors 142 as well as to the other components of the processing system 100. As an example, based on address data indicated in a packet received from a first component (e.g., CPU 102), the PCI switch 146 routes the packet to a corresponding component (e.g., AU 110) connected to the PCI connectors 142.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 112, displays the scene on the display 130, or both. The display 130, for example, includes a cathode-ray tube (CRT) display, liquid crystal display (LCD), light emitting diode (LED) display, organic light emitting diode (OLED) display, or any combination thereof. To enable the processing system 100 to display a scene on the display 130, the I/O circuitry 114 includes display circuitry 148. The display circuitry 148, for example, includes high-definition multimedia interface (HDMI) connectors, DisplayPort connectors, digital visual interface (DVI) connectors, USB connectors, and the like, each including circuitry configured to communicatively couple the display 130 to the I/O circuitry 114. Additionally or alternatively, the display circuitry 148 includes circuitry configured to manage the display of one or more scenes on the display 130 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 114 includes memory management unit (MMU) 146 and input-output memory management unit (IOMMU) 148. The MMU 150 includes, for example, circuitry configured to manage memory requests, such as from the CPU 102 to the system memory 106. For example, the MMU 150 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 150 is configured to translate the virtual address indicated in the memory request to a physical address in the system memory 106 and to fulfill the request. The IOMMU 152 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 144 of the I/O device 108, the registers 140 of the AU 110, and/or the AU memory 138, the CPU 102 issues one or more MMIO requests. Such MMIO requests each request access to read, write, fetch, or pre-fetch data residing at one or more virtual addresses (e.g., guest virtual addresses) which each represent at least a portion of the registers 144 of the I/O device 108, the registers 140 of the AU 110, or the AU memory 138, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 152 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1. Additionally or alternatively, in at least one variation, the processing system 100 includes additional and/or different components from those depicted. The processing system 100 is configurable in a variety of ways with different combinations of components in accordance with the described techniques.

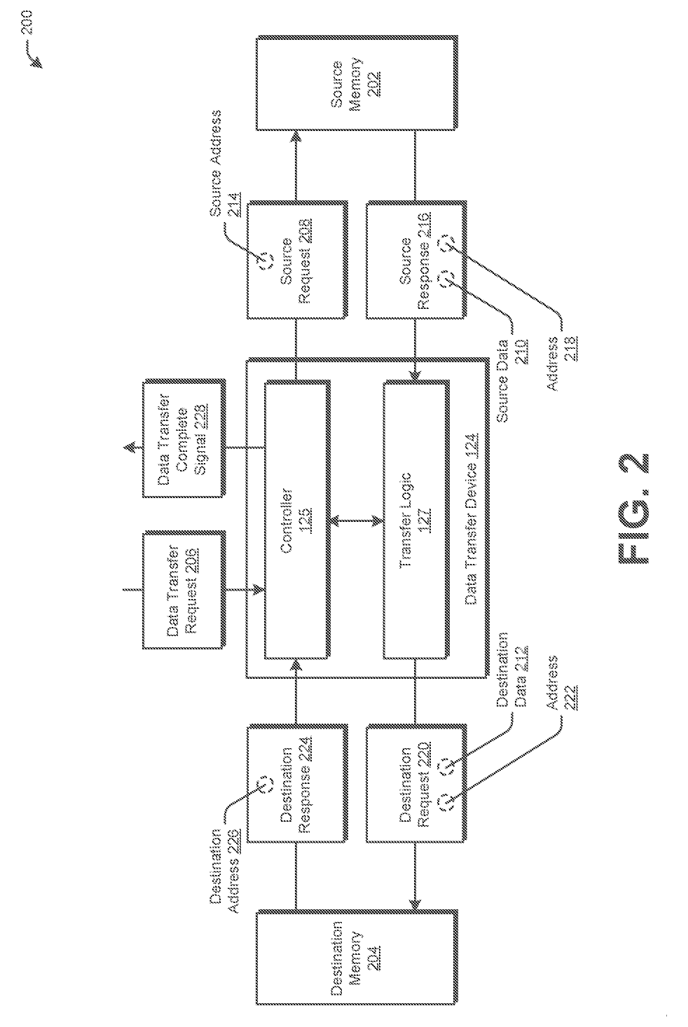

FIG. 2 is a block diagram of a non-limiting example system 200 having a data transfer device to transfer data between heterogeneous memory systems.

The system 200 includes the data transfer device 124 having the controller 125 and the transfer logic 127. The illustrated example also depicts a source memory 202 and a destination memory 204. While illustrated in this example as being separate, in at least one variation, the source memory 202 and the destination memory 204 are simply different memory “spaces” of a same memory device, e.g., implemented using a same memory chip (e.g., a same dynamic random access memory (DRAM) chip), a same dual inline memory module (DIMM), a group of connected DIMMs, and so forth.

In accordance with the described techniques, a device or system that accesses memory in a first manner (e.g., a first pattern, first addressing scheme, requiring data in a first format, etc.) sends a data transfer request 206 to the controller 125. Examples of such a device or system include a central processing unit (CPU), a compute unit, an accelerated unit, and a network interface card (NIC), to name just a few, and examples of the data transfer request 206 include a direct memory access (DMA) request. Based on the data transfer request 206, the controller 125 issues one or more source requests 208 (e.g., a series of requests) to obtain (e.g., read) source data 210 from a location in the source memory 202.

The source data 210 is provided to the transfer logic 127, which performs at least one transfer operation to optimize transfer of the source data 210 from the source memory 202 to the destination memory 204. By way of example, the transfer logic 127 performs one or more transfer operations to optimize the transfer, such as operations to control a data access order, rearrange the data, and/or manipulate the data. In one or more implementations, the transfer operations performed are based, at least in part, on a device or system that accesses memory in a second, heterogeneous manner (e.g., a second pattern, second addressing scheme, requiring data in a second format, etc.). Additionally or alternatively, the transfer operations performed are based on the device or system that accesses memory in the first manner. Like the device issuing the data transfer request 206 (e.g., a DMA request), examples of a device or system that accesses memory in the second, heterogenous manner can include a central processing unit (CPU), a compute unit, an accelerated unit, and a network interface card (NIC), to name just a few. The transfer logic 127 outputs and transfers destination data 212 to the destination memory 204. When a transformation operation such as a data rearrangement or data manipulation is requested in the data transfer request 206, for instance, the transfer logic 127 transforms the source data 210 to produce the destination data 212. Alternatively, or additionally, the transfer logic 127 controls how the source data 210 is accessed at (e.g., read from) the source memory 202 and/or how the destination data 212 is accessed at (e.g., written to) the destination memory 204. The data is accessible from the destination memory 204 by the device that accesses the memory in the second, heterogeneous manner. In at least one variation, the data transfer device 124 obtains the source data 210 optimizes a transfer of the data to the destination memory 204, where it is written as destination data 212, by performing at least one data transfer operation during the transfer, examples of which are enumerated above. In particular, the data transfer device 124 transfers the data in an optimized manner by performing at least one data transfer operation independently of a device or system which issued the data transfer request 206, e.g., independently of a CPU or GPU.

In one or more implementations, the data transfer request 206 (e.g., a DMA request) identifies information for accessing the source data 210 from a location in the source memory 202 and, when a transformation is requested, information for transforming the source data 210 to produce manipulated and/or rearranged destination data 212. In one or more implementations, the data transfer request 206 also identifies information for accessing the destination data 212 from the destination memory 204, e.g., by a device that accesses memory heterogeneously. Examples of this information include but are not limited to source data location information (e.g., a base address and/or a size of the source data 210 in the source memory 202), a function for mapping a source address to a destination address, source address order preferences, and destination access preferences.

The one or more source requests 208 each include at least one source address 214 that defines a location in the source memory 202 from which at least a portion of the source data 210 can be accessed (e.g., read or written to). The source data 210 is provided from the source memory 202 to the transfer logic 127 using one or more source responses 216. In at least one scenario, an access order of the source data 210 from the source memory 202 is controlled (e.g., specified) by the transfer logic 127. These source responses 216 include at least a portion of the source data 210 and an address 218 associated with the source data 210 (or portion thereof) provided in the respective source response. By issuing a series of the source requests 208, the controller 125 is capable of accessing the source data 210 from the source memory 202, such as according to a specified access order. The controller 125 can also transfer the data to the destination memory 204 according to a specified access order based on a mapping function.

The transfer logic 127 is configured to perform at least one data transfer operation to optimize the transfer of the data from the source memory 202 location to the destination memory 204 location. This can include performing a transfer operation even during operations like memcopy operations. In variations, for example, the transfer logic 127 is configured to rearrange one or more portions (e.g., data elements) of the source data 210 accessed from the source memory 202 to produce and output the destination data 212. Alternatively or additionally, the transfer logic 127 is configured to manipulate (e.g., modify) one or more portions of the source data 210 accessed from the source memory 202 to produce and output the destination data 212. As mentioned above, the transfer logic 127 is also configured to control a data access order of the data at the source memory 202 and/or the destination memory 204 to optimize the transfer. The transfer logic 127 can be implemented in different ways in variations. For example, the transfer logic 127 may be or include a circuit or circuitry configured to perform any of a variety of transfer operations to optimize transfer of data maintained in a first memory space (e.g., the source memory 202) so that it can be maintained subsequently in a second, heterogenous memory space (e.g., the destination memory 204). In one or more implementations, at least a portion of such a circuit or circuitry is printed on or otherwise applied to (e.g., etched on) a die, an example of which is an intellectual property (IP) block.

As mentioned above, the transfer logic 127 outputs the destination data 212 and transfers the destination data 212 to the destination memory 204, where the transformed data 212 is accessible by a device or system that accesses the data from memory in a second manner that is heterogeneous to the first manner in which the device or system the issued the data transfer request 206 accesses data in memory. In one or more implementations, the destination data 212 is transferred to the destination memory 204 via one or more destination requests 220. The one or more destination requests 220 each include at least one address 222 that defines a location in the destination memory 204 to which at least a portion of the destination data 212 provided in the particular request, can be written. The address 222 also defines the location in the destination memory 204 from which the portion of the destination data 212 sent in the respective destination request 220 can be accessed, e.g., by the system or device accessing data from the memory in the second manner. As noted above, the destination data 212 can be written to the destination memory 204 in a data access order controlled by the transfer logic 127, such as an access order that is based on a mapping function.

In one or more implementations, the controller 125 receives one or more destination responses 224. Those destination responses 224 include one or more destination addresses 226, which define a location in the destination memory 204 from which at least a portion of the transformed data 212 can be accessed (e.g., read or written to). In one or more implementations, the destination addresses 226 enable the device or system accessing the data in the second manner to access the transformed data 212 from the destination memory 204. In at least one variation, the one or more destination addresses 226 are the same as the address 222. In at least one alternative implementation, the address 222 defines a location in the destination memory 204 for only the portion of the transformed data 212 transferred to the destination memory 204 in the particular destination request 220, e.g., the destination data 212 provided in the particular destination request 220.

After the destination responses 224 (e.g., all of them) have been received by the controller 125, indicating that the transformed data 212 is available for access in the destination memory 204, the controller 125 may output a data transfer complete signal 228. For example, the controller 125 may issue the data transfer complete signal to the system or device that accesses data in memory in a first manner and/or to the system or device that accesses data in memory in a second, heterogeneous manner.

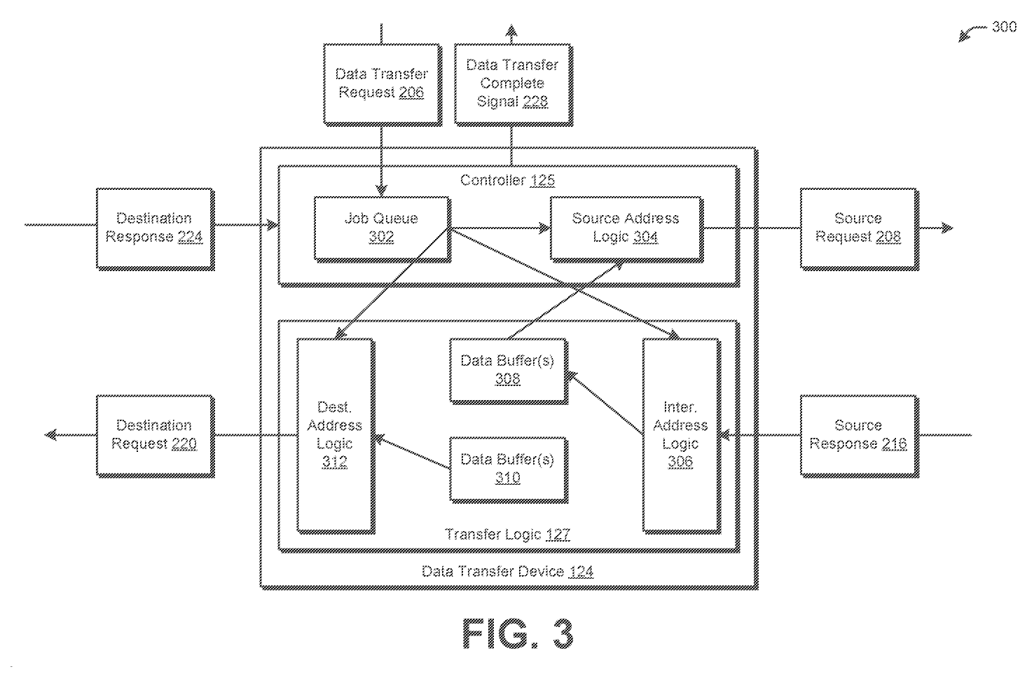

FIG. 3 is a block diagram of another non-limiting example system 300 having a data transfer device to transfer data between heterogeneous memory systems.

The system 300 includes the data transfer device 124 having the controller 125 and the transfer logic 127, as previously described in relation to FIGS. 1 and FIG. 2. In this implementation, the controller 125 is depicted having additional components to manage data transfer operations between heterogeneous memory systems.

For example, the controller 125 incorporates a job queue 302, which receives and manages multiple data transfer requests 206, e.g., memory access requests such as DMA requests. The job queue 302 prioritizes and schedules data transfer operations based on various factors such as urgency, resource availability, or system optimization strategies. This queuing mechanism allows for efficient handling of concurrent data transfer requests from different sources or applications.

Coupled to the job queue 302, the controller 125 includes source address logic 304. The source address logic 304 generates and manages the appropriate source memory addresses for data retrieval operations, such as by generating the source addresses 214 for the source requests 208. The source address logic 304 works in conjunction with the job queue 302 to ensure that data is accessed from the correct locations in the source memory 202 for each queued transfer operation.

The transfer logic 127 in this example is depicted in more detail as including numerous components. Intermediate address logic 306 is depicted, which manages addressing for temporary data storage during transfer operations, such as for temporary storage in intermediate buffers. For example, the temporary storage in these intermediate data buffers facilitates the performance of transfer operations such as controlling data access order, data rearrangement, and data manipulation. In one or more implementations, the intermediate address logic 306 includes circuitry to generate addresses for storing one or more portions of the source data 210 in intermediate buffers at least temporarily. In the illustrated example, such intermediate buffers include data buffer(s) 308 and 310. The inclusion of the intermediate address logic 306 and intermediate buffers is particularly useful, for example, for complex data transformations involving multiple steps or intermediate results.

In one or more implementations, at least two data buffers, 308 and 310, are incorporated within the transfer logic 127. These buffers provide temporary storage for data as it is accessed in a controlled order and/or undergoes transformation operations. The use of multiple buffers allows for parallel processing of data, potentially improving the overall efficiency of the data transfer and transformation process and/or allowing multiple transfer operations to be performed on the data.

The transfer logic 127 is also depicted including destination address logic 312. This component generates the appropriate destination memory addresses for storing the destination data 212 in the destination memory 204. The destination address logic 312 works in tandem with the intermediate address logic 306 to ensure that the data is correctly mapped to its intended locations in the destination memory 204.

In operation, the system 300 receives data transfer requests 206 into the job queue 302. The controller 125 processes these requests, utilizing the source address logic 304 to retrieve data from locations in the source memory 202 specified by the addresses output by the source address logic 304. The retrieved data is then accessed by and/or passes through the transfer logic 127 at locations defined by the addresses generated by the intermediate address logic 306. While passing through the transfer logic, the retrieved data is temporarily stored in data buffers 308 and/or 310 and, in some scenarios, undergoes address and/or data transformations.

When the data is transformed, the data is manipulated or rearranged according to the specific requirements of the destination system or device. For instance, this may involve operations such as data format conversion, reordering of data elements, or more complex transformations. Once the data has been transformed or in scenarios where no transformation is performed (e.g., in connection with a memcopy operation), the destination address logic 312 generates the appropriate addresses for storing the retrieved data in the destination memory 204. The retrieved data is then sent to the destination memory 204 using a destination request 220, as described in relation to FIG. 2.

The system 300 also handles responses from the source and destination memories. The data transfer device 124 receives source responses 216 containing the requested source data, and destination responses 224 confirming the successful storage of transferred data. Upon completion of a data transfer operation, the data transfer device 124 issues a data transfer complete signal 228, indicating that the transformed data is available for access in the destination memory.

This architecture may allow for efficient and flexible data transfer between heterogeneous memory systems, with the ability to perform complex data transformations and address remapping during the transfer process. The inclusion of multiple buffers and specialized address logic may enable parallel processing and optimization of data transfers, potentially improving overall system performance in scenarios involving diverse memory architectures and data formats.

In one or more implementations, the system 300 enables optimization of the source and destination access patterns by allowing memory accesses associated with data transfer requests 206 to be reordered with low overhead via intermediate storage, as illustrated in FIG. 3. In one or more implementations, this reordering is carried out in accordance with the following discussion.

A device sends a data transfer request 206 to the job queue 302 of the controller 125 identifying the source data location information (e.g., base address and size), a mapping function for mapping source addresses to destination addresses, source access order preferences, and/or destination access order preferences. In at least one implementation, there are no restrictions regarding the base addresses and sizes between subsequent memory access requests.

The controller 125 generates an access order function that balances the locality and concurrency demands of the source and destination accesses, and programs the access order function into the source address logic 304, the intermediate address logic 306, and the destination address logic 312.

The source address logic 304 begins issuing source requests 208 to the source memory 202. Source responses 216 are mapped to data buffers 308 and 310. Buffer free space is communicated to the source address logic 304, which in some cases blocks if the buffers fill up.

When an intermediate buffer (e.g., data buffers 308 and 310) has been filled with data, the destination address logic 312 reads data from the buffer in an order initially defined by the controller 125, generates the corresponding destination addresses 226, and sends store requests to the target destination location in an optimized order.

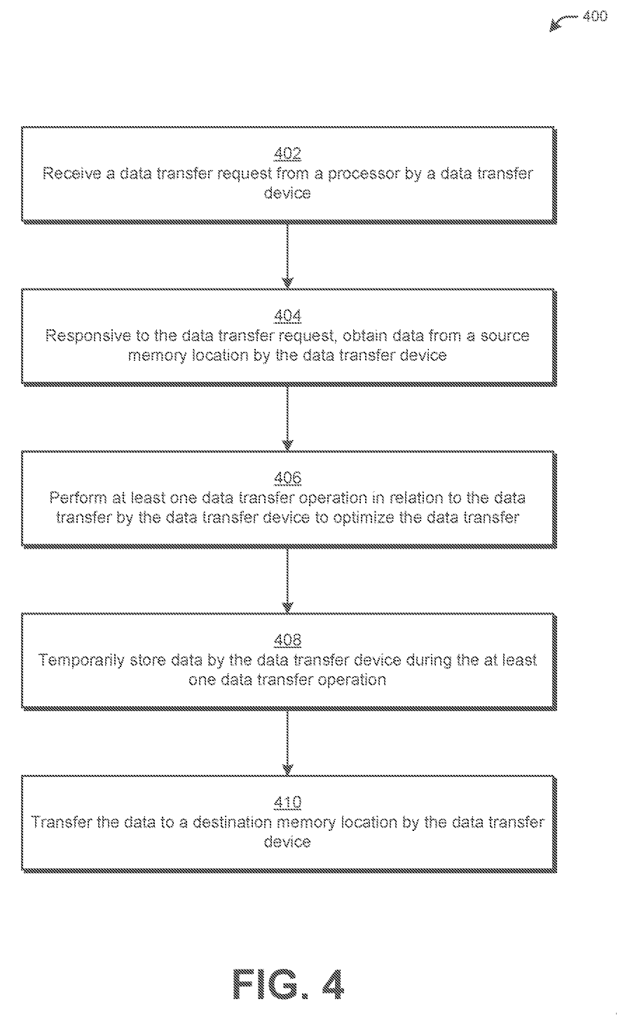

FIG. 4 depicts a procedure in an example 400 implementation of data transfer for heterogeneous memory systems.

A data transfer request is received from a processor by a data transfer device (block 402). In one or more implementations, the controller 125 of the data transfer device 124 receives a data transfer request 206 from a processor, such as CPU 102. The processor may hand off the data transfer operation to the data transfer device 124 and does not have to perform any further actions related to the data transfer. This allows the processor to offload the data transfer task and focus on other operations while the data transfer device 124 independently handles optimizing the data transfer by obtaining the data from the source memory, performing any necessary transfer operations (e.g., modifications of data access order or data transformations such as data rearrangement and/or data manipulation), and transferring the data to the destination memory.

Data is obtained from a source memory location by the data transfer device, responsive to the data transfer request (block 404). For example, the controller 125 issues one or more source requests 208 to obtain source data 210 from a location in the source memory 202.

At least one data transfer operation is performed in relation to the data transfer by the data transfer device to optimize the data transfer (block 406). In some scenarios, the transfer logic 127 of the data transfer device 124 performs one or more data transfer operations on the source data 210 to optimize the transfer of the data 212, such as controlling data access order and/or manipulating or rearranging the data. These data transfer operations may include various types of operations to control a data access order and/or to transform (e.g., modify and/or rearrange) the data. For example, data transformations may include converting between array-of-structure (AoS) and structure-of-array (SoA) formats, which can optimize data layout for different processing units. Other examples of such transformations include compressing or decompressing data, sampling or subsampling large datasets, converting between sparse matrix formats like CSR and CSC, performing image-to-column (im2col) transformations for neural network operations, or converting between different numeric data types. Performing such transformations during data transfer can provide advantages such as reducing a total amount of data transferred, optimizing data formats for the destination device, enabling efficient processing of large datasets, and avoiding performance of separate transformation steps after a data transfer. Specific orders for accessing data (at either the source or destination memories) and specific transformations performed may be tailored to the requirements of the source and destination devices or memory systems.

Data is temporarily stored by the data transfer device during the at least one data transfer operation (block 408). For instance, the transfer logic 127 utilizes data buffers 308 and/or 310 to temporarily store data as transfer operations are performed, such as while data is being accessed in a controlled access order and/or while the data undergoes one or more transformations. In some scenarios, these data buffers provide intermediate storage space for holding portions of the data while complex transformations are performed. The use of multiple buffers, such as data buffers 308 and 310, may allow for parallel processing of data in some cases, potentially improving the overall efficiency of the data transfer process. Additionally, the intermediate address logic 306 may manage addressing for this temporary data storage, generating appropriate addresses for storing and retrieving data from the buffers during the transfer operations. This temporary storage and addressing scheme may enable the data transfer device to handle more complex data access orders and/or data transformations that require multiple steps or intermediate results.

The data is transferred to a destination memory location by the data transfer device (block 410). In one or more implementations, the controller 125 issues one or more destination requests 220 to transfer the destination data 212 to a location in the destination memory 204. In some cases, for instance, the data transfer device 124 notifies the processor (e.g., the CPU 102 or the AU 110) that the transfer is complete after the destination data 212 is transferred to the destination memory 204 location. For instance, the controller 125 issues a data transfer complete signal 228 to the processor. This notification allows the processor to know when the transferred data is available in the destination memory, which may improve overall system efficiency by enabling the processor to begin using or processing the transferred data as soon as it is ready. Additionally, the ability to perform data access operations and/or transformations during transfer and notify the processor upon completion may reduce the need for separate access-order or transformation steps or polling by the processor, potentially streamlining data movement operations in heterogeneous memory systems.

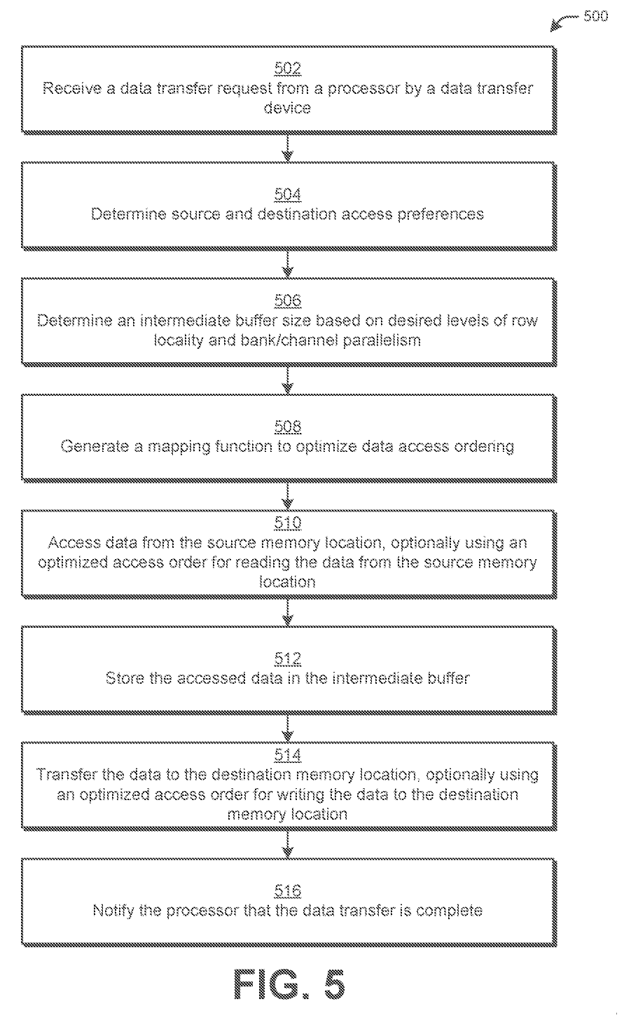

FIG. 5 depicts a procedure in an example 500 implementation of optimizing data access order for dynamic random access memory (DRAM) access optimization. In particular, access order is optimized to balance spatial locality and concurrency.

A data transfer request is received by a data transfer device (block 502). For example, the controller 125 of the data transfer device 124 receives a data transfer request 206 specifying source and destination memory locations. In one or more implementations, the request specifies source and destination access preferences.

Source and destination access preferences are determined (block 504). In one or more implementations, the controller 125 analyzes the source memory 202 and destination memory 204 characteristics to determine preferences for spatial locality and concurrency. For instance, the controller 125 determines preferences for DRAM row locality and bank/channel parallelism.

An intermediate buffer size is determined based on desired levels of row locality and bank/channel parallelism (block 506). For instance, the controller 125 calculates a required buffer size based on parameters such as L_{src}, L_{dest}, P_{src}, and P_{dst}, which represent desired levels of source and destination row locality and bank/channel parallelism respectively.

A mapping function is generated to optimize data access ordering (block 508). In one or more scenarios, the source address logic 304 and destination address logic 312 generate mapping functions that balance spatial locality and concurrency for both source and destination memories. This involves scheduling accesses to addresses that only differ in certain address bits together for spatial locality, and scheduling accesses that minimally differ in certain address bits together for concurrency. In one or more scenarios, the optimized data access order is utilized for accessing the data at only one of the source memory location or the destination memory location, not both. This is because in such scenarios it is assumed that the data is in a suitable layout for either the data source (e.g., a source processor) or the data destination (e.g., a destination processor), e.g., the optimization needs to happen at either the source or the destination.

Data is accessed from the source memory location, optionally using an optimized access order for reading the data from the source memory location (block 510). For example, the controller 125 issues source requests 208 to the source memory 202. In scenarios where the access order is controlled at the source, the controller 125 issues the source requests 208 to the source memory 202 following the optimized access pattern. This involves traversing different banks in the same channel, then different columns within those same rows. In one or more scenarios, if an access order is optimized at the source it is not also optimized later at the destination.

The accessed data is stored in the intermediate buffer (block 512). In one or more implementations, the data is temporarily stored in data buffers 308 and 310 within the transfer logic 127. The intermediate buffer layout is optimized based on the source and destination access preferences. While with the transfer logic 127, in one or more scenarios, the data is transformed by one or more transformation operations, such as to modify the data and/or to rearrange the data.

The data is transferred to the destination memory location using the optimized access order, optionally using an optimized access order for writing the data to the destination memory location (block 514). For instance, the controller 125 issues destination requests 220 to the destination memory 204. In scenarios where the access order is controlled at the destination, the controller 125 issues the destination requests 220 to the destination memory 204 following the optimized access pattern for the destination. This may involve traversing different banks and columns in an order that balances locality and parallelism. In one or more scenarios, if an access order is optimized at the destination it is not also optimized at the source.

In one or more implementations, the data transfer device notifies the processor that the optimized data transfer is complete (block 516). For example, the controller 125 issues a data transfer complete signal 228 to indicate the completion of the optimized data transfer process.

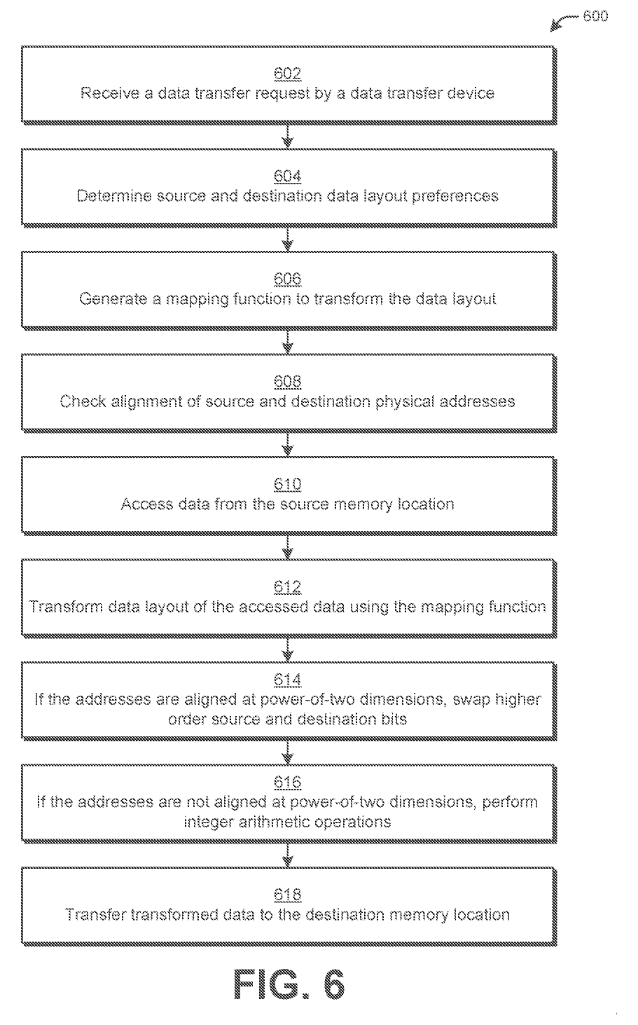

FIG. 6 depicts a procedure in an example 600 implementation of data structure layout transformation for heterogeneous memory systems.

A data transfer request is received by a data transfer device (block 602). For example, the controller 125 of the data transfer device 124 receives a data transfer request 206 specifying source and destination memory locations with different preferred data layouts.

Source and destination data layout preferences are determined (block 604). In one or more implementations, the controller 125 analyzes the source memory 202 and destination memory 204 characteristics to determine, for instance, if the source or destination memory system prefers a structure-of-array (SoA) layout and the other an array-of-structure (AoS) layout.

A mapping function is generated to transform the data layout (block 606). For instance, the transfer logic 127 may generate a mapping function to convert between SoA and AoS layouts based on the determined preferences. In some aspects, this mapping may be determined at compile time.

The alignment of source and destination physical addresses is checked (block 608). In some aspects, the controller 125 may determine if the addresses are aligned at power-of-two dimensions.

Data is accessed from the source memory location (block 610). For example, the controller 125 may issue source requests 208 to the source memory 202 to retrieve the data in its original layout. In some implementations, this may involve reading data written by GPU threads in their preferred SoA layout.

The data layout of the accessed data is transformed using the mapping function (block 612). In one or more implementations, the transfer logic 127 may rearrange the data elements according to the generated mapping function.

If the addresses are aligned at power-of-two dimensions, higher order source and destination bits are swapped (block 614). For instance, if the condition in block 608 is met, the transfer logic 127 may perform this bit-swapping operation for address transformation.

If the addresses are not aligned at power-of-two dimensions, integer arithmetic operations are performed (block 616). For example, if the condition in block 608 is not met, the destination address logic 312 may perform these operations to convert source to intermediate and destination addresses.

The transformed data is transferred to the destination memory location (block 618). For instance, the controller 125 may issue destination requests 220 to the destination memory 204 to store the data in its new layout, which may be the layout expected by the CPU or other hardware.

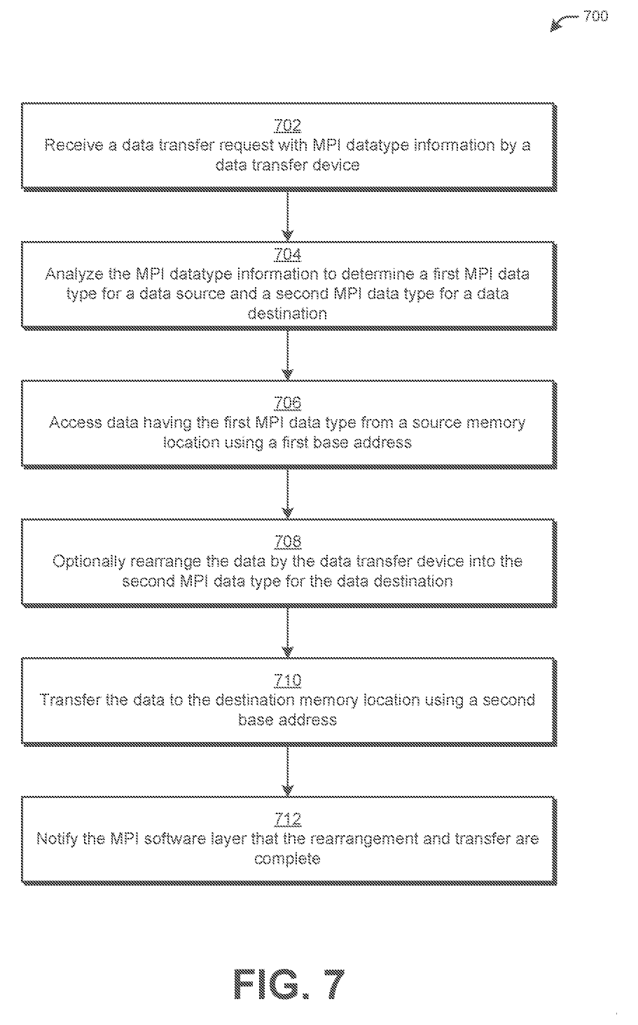

FIG. 7 depicts a procedure in an example 700 implementation of message passing interface (MPI) datatype transfer support for heterogeneous memory systems.

A data transfer request with MPI datatype information is received by a data transfer device (block 702). For example, the controller 125 of the data transfer device 124 receives a data transfer request 206 that includes MPI datatype information describing a layout and structure of data in memory, such as a fist MPI data type for a data source and a second MPI data type for a data destination.

The MPI datatype information is analyzed to determine a first MPI data type for a data source and a second MPI data type for a data destination (block 704). In one or more implementations, the controller 125 interprets the MPI datatype information to understand a data structure being transferred between the data source and data destination along with a first MPI data type for the source of the data and a second MPI data type for the destination of the data, which may be composed of any of a variety of fundamental types and other data structures.

Data having the first MPI data type is accessed from a source memory using a first base address (block 706). For example, the controller 125 may issue source requests 208 to the source memory 202 to retrieve the data based on the MPI datatype description.

The data is optionally rearranged by the data transfer device into the second MPI data type for the data destination (block 708). In one or more implementations, the transfer logic 127 may rearrange and pack the data elements according to the a mapping function or other transformation mechanism.

The data (e.g., as rearranged) is transferred to the destination memory location using a second base address (block 710). For example, the controller 125 may issue destination requests 220 to the destination memory 204 to store the data in its new, packed layout suitable for MPI communication.

The data transfer device notifies an MPI software layer that the rearrangement and transfer are complete (block 712). For instance, the controller 125 may issue a data transfer complete signal 228 to indicate the completion of the MPI datatype transform and transfer process.

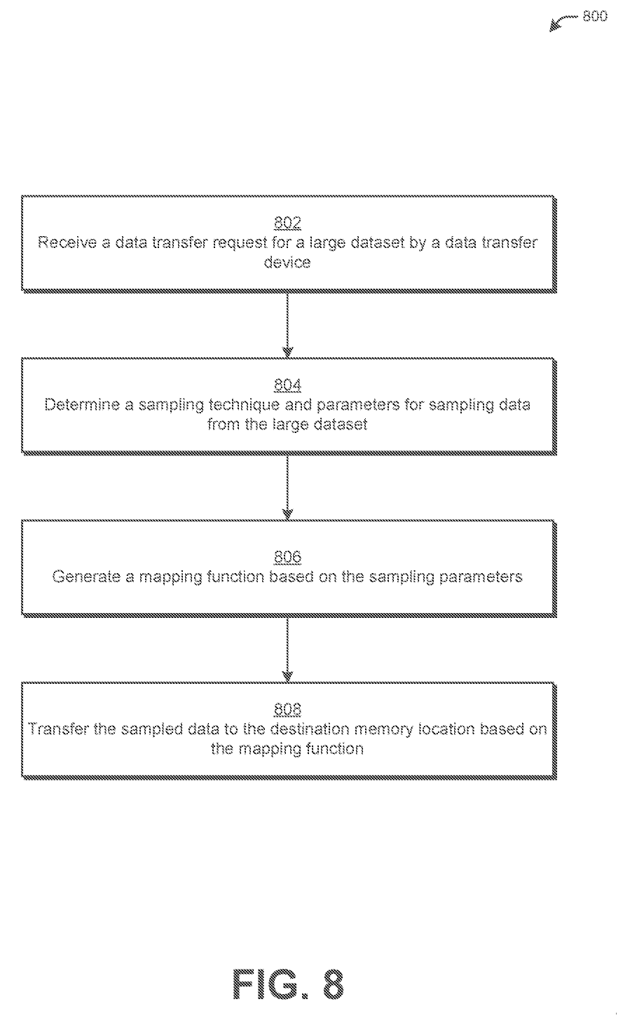

FIG. 8 depicts a procedure in an example 800 implementation of sampling large datasets for heterogeneous memory systems.

A data transfer request for a large dataset is received by a data transfer device (block 802). For example, the controller 125 of the data transfer device 124 receives a data transfer request 206 specifying a large input tensor to be sampled.

A sampling technique and parameters are determined for sampling data from the large dataset (block 804). In one or more implementations, the controller 125 may select a technique such as perforated convolutions and determine parameters like whether to remove rows or columns, the stride for removal, and an optional offset. In accordance with the described techniques, these parameters can be communicated to a DMA engine in the form of a source address to destination address mapping function.

A mapping function is generated based on the sampling parameters (block 806). The transfer logic 127 may create a source address to destination address mapping function that implements the defined sampling strategy. This sampling function may also take into account prior data values in deciding subsequent sampling patterns, e.g., to start or stop sampling based on data properties.

The sampled data is transferred to the destination memory location based on the mapping function (block 808). For example, the controller 125 may issue destination requests 220 to the destination memory 204 to store the sampled data. The sender can trigger smart transfer of the input tensor, and the receiver would receive the sampled input with removed rows/columns, reducing the amount of computation and the amount of data transferred to and stored on the destination accelerator.

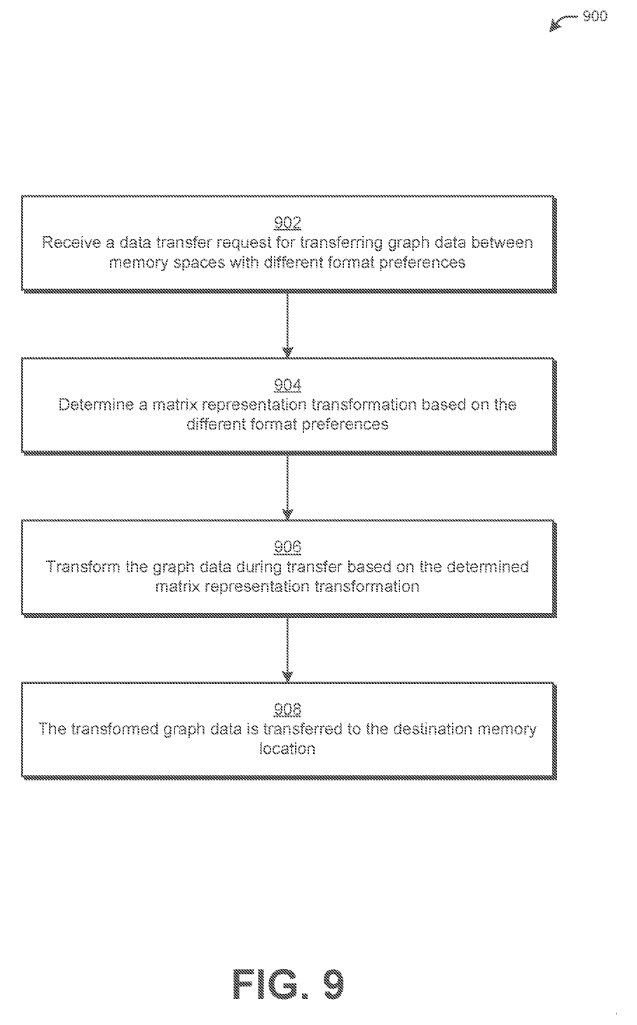

FIG. 9 depicts a procedure in an example 900 implementation of graph data transformation for heterogeneous memory systems.

A data transfer request for transferring graph data between memory spaces with different format preferences is received by a data transfer device (block 902). For example, the controller 125 of the data transfer device 124 receives a data transfer request 206 specifying graph data to be transferred between memory spaces with different format preferences.

A matrix representation transformation is determined based on the different format preferences (block 904). In one or more implementations, the controller 125 may determine whether to transform the graph data from compressed sparse row (CSR) to compressed sparse column (CSC) format, or vice versa, based on the preferences of the source and destination systems.

The graph data is transformed during transfer based on the determined matrix representation transformation (block 906). For instance, the transfer logic 127 may perform the matrix representation transformation while the graph index data is being transferred between memory spaces, modifying streaming indices using basic integer arithmetic.

The transformed graph data is transferred to the destination memory location (block 908). For example, the controller 125 may issue destination requests 220 to the destination memory 204 to store the graph data in its new format, enabling efficient traversal without the need for maintaining duplicate representations or performing separate transformations.

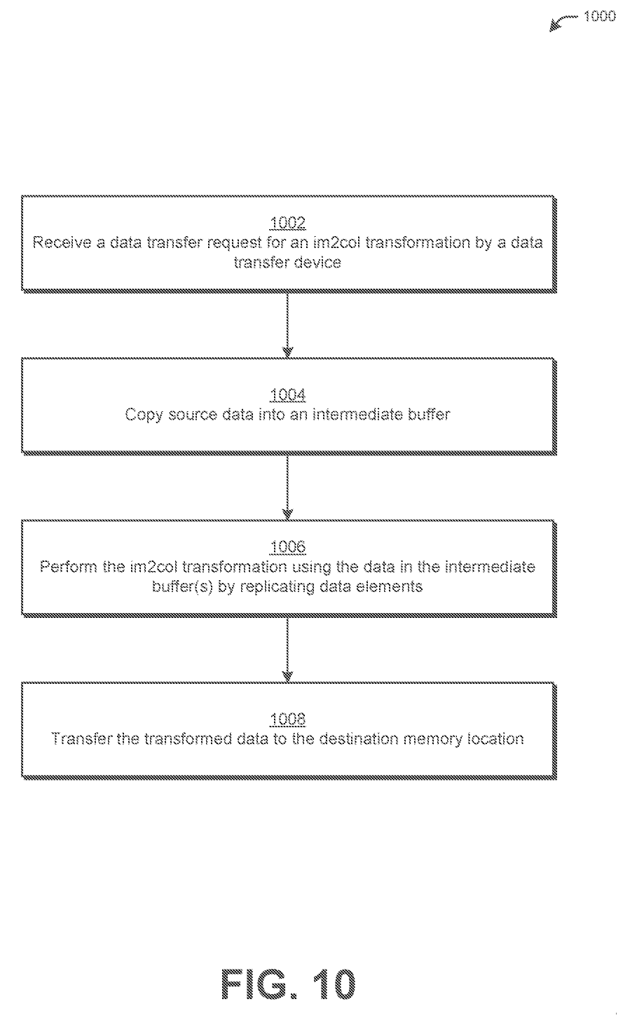

FIG. 10 depicts a procedure in an example 1000 implementation of matrix transformation for deep neural networks using a data transfer device.

A data transfer request for an im2col transformation is received by a data transfer device (block 1002). For example, the controller 125 of the data transfer device 124 receives a data transfer request 206 specifying a convolution operation to be converted to a matrix multiplication for artificial intelligence, such as for a machine learning model, e.g., a deep neural network.

Source data is copied into an intermediate buffer (block 1004). In one or more implementations, the transfer logic 127 copies the necessary data from the source memory 202 into data buffers 308 and 310.

The im2col transformation is performed using the data in the one or more intermediate buffers by replicating data elements (block 1006). For instance, the transfer logic 127 may load data repeatedly from the intermediate buffers as needed for the destination access pattern, effectively performing the im2col kernel operation.

The transformed data is transferred to the destination memory location (block 1008). For example, the controller 125 may issue destination requests 220 to the destination memory 204, placing the transformed matrix data close to where it will be used for matrix multiplication, accounting for the potential bandwidth imbalance between source and destination.

As various accelerators are explored and introduced, they may utilize or prefer different data types (e.g., Int, fp32, TensorFloat, fp24, PXR24). The data transfer device 124 can accommodate the different formats between accelerators that are linked in a virtual pipeline and transparently convert between the different types. For example, the controller 125 may receive a data transfer request 206 from a sender to trigger a transfer of a given data block. The transfer logic 127 can then perform data type conversion operations on the source data 210 as it is transferred. The receiver can then receive the transformed data 212 in a preferred format via a destination request 220 to the destination memory 204. This may require minimal additional conversion logic within the data transfer device 124.

By placing the data transfer device 124 at strategic locations in the network, the cost of conversion logic can be efficiently shared among multiple accelerators. This may avoid the need to include separate convert/deconvert structures in every new accelerator to support compatibility.

A number of implementations have been described. Nevertheless, it will be understood that various modifications may be made without departing from the spirit and scope of the disclosure. Accordingly, other implementations are within the scope of the following claims.

What is claimed is:

1. A data transfer device comprising:
a controller configured to:
receive a data transfer request from a processor; and
responsive to the data transfer request, obtain data from a source memory location and transfer the data to a destination memory location; and
transfer logic configured to optimize the transfer of the data from the source memory location to the destination memory location by performing at least one data transfer operation.

2. The data transfer device of claim 1, wherein the data transfer device obtains the data, performs the at least one data transfer operation on the data, and transfers the data to the destination memory location independently of the processor.

3. The data transfer device of claim 1, wherein controller is further configured to notify the processor that the transfer is complete after an optimized transfer of the data to the destination memory location.

4. The data transfer device of claim 1, wherein the source memory location and the destination memory location are in different types of memory.

5. The data transfer device of claim 1, wherein the data transfer request identifies the source memory location, the destination memory location, and a size of the data.

6. The data transfer device of claim 1, wherein the at least one data transfer operation comprises rearranging data elements of the data to generate transformed data.

7. The data transfer device of claim 1, wherein the at least one data transfer operation comprises manipulating the data to generate transformed data.

8. The data transfer device of claim 1, wherein the data transfer request specifies a source address to destination address mapping function.

9. The data transfer device of claim 8, wherein the at least one data transfer operation comprises controlling an access order to obtain the data from the source address or transfer the data to the destination based on the mapping function.

10. The data transfer device of claim 9, wherein the access order is modified to optimize for memory architecture characteristics of the source memory location and the destination memory location.

11. The data transfer device of claim 1, further comprising at least one intermediate storage buffer configured to temporarily store data during the at least one data transfer operation.

12. The data transfer device of claim 1, further comprising source address generation logic, intermediate address generation logic, and destination address generation logic.

13. The data transfer device of claim 1, wherein the transfer logic is coupled to the controller.

14. The data transfer device of claim 1, wherein the transfer logic is implemented as a part of the controller.

15. A system comprising:
a processor;
memory comprising a first memory space and a second memory space, the second memory space being heterogeneous to the first memory space; and
a data transfer device configured to:
receive a data transfer request from the processor;
responsive to the data transfer request, obtain data from a first memory location in the first memory space;
transfer the data from the first memory location to a second memory location in the second memory space; and
optimize the transfer of the data from the first memory location to the second memory location by performing at least one data transfer operation.

16. The system of claim 15, wherein the first memory space and the second memory space are implemented using different physical memory systems.

17. The system of claim 15, wherein the first memory space and the second memory space are implemented at a same physical memory module.

18. A method comprising:
receive, by a data transfer device, a data transfer request from a processor;
responsive to the data transfer request, obtain, by the data transfer device, data from a source memory location;
temporarily store, by the data transfer device, the data during at least one data transfer operation performed by the data transfer device to optimize transfer of the data between the source memory location and a destination memory location; and
transfer, by the data transfer device, the data to the destination memory location.

19. The method of claim 18, further comprising:
generating, by the data transfer device, a mapping function for converting source addresses to destination addresses; and
modifying, by the data transfer device, an access order for obtaining the data from the source memory location or transforming the data for transfer to the destination memory location based on the mapping function.

20. The method of claim 19 wherein transforming the data for transfer comprises at least one of:
rearranging data elements of the obtained data to generate transformed data; and
converting the obtained data from a first data type to a second data type.
